(19) United States
(12) Patent Application Publication
(10) Pub. No.: US 2014/0257903 A1
(43) Pub. Date: Sep. 11, 2014

(54) SCHEDULING SYSTEM

(71) Applicant: Art2Wave Inc., Ottawa (CA)

(72) Inventors: Bernard HERSCOVICI, Ottawa (CA); Avi LIOR, Ottawa (CA)

(21) Appl. No.: 13/790,280

(22) Filed: Mar. 8, 2013

(51) Int. Cl. G06Q 10/10

(52) U.S. Cl. CPC G06Q 10/1095
USPC 705/7.19

(57) ABSTRACT

Systems, methods, and devices for managing appointments. A sensor module receives sensor data input. The sensor data is then analyzed by an analysis module which determines if actions are required. In the event actions are required, a scheduling module checks a user's calendar to determine if a suitable opening is available. In the event a suitable opening is available, the opening is confirmed with the user. If the user confirms the opening, an appointment is entered in the user's calendar. If the action required needs external assistance, such as a mechanic, the scheduling module also checks the relevant calendar for the external assistance. Suitable openings are then found in both the user's calendar and the relevant external assistance calendar. If these openings match, the user is then contacted to confirm if the opening is acceptable. If the opening is acceptable, the appointment is then entered in both calendars.

### TECHNICAL FIELD

The present invention relates to scheduling systems. More specifically, the present invention relates to scheduling systems which receive sensor data input and, based on the analysis of the sensor data, automatically schedules relevant appointments.

### BACKGROUND OF THE INVENTION

The high tech revolution of the past two decades has changed how people are managing their day to day affairs. Increasingly, we are letting sensors into our lives to help us monitor our health, our homes, our cars. Technology now exists to monitor our blood pressure, blood sugar, and other health indicators. Similarly, technology now exists for monitoring our houses—everything from home security to humidity and temperature can now be monitored. In terms of automobiles, sensors can now monitor tire pressure, cabin temperature, engine pressures, and even the presence of passengers.

The data generated by these sensors are currently used to trigger alarms whenever readings indicate conditions exceed acceptable parameters. This increasing number of sensors can have the effect of complicating modern life. As more components are monitored, alarms which need to be attended to can proliferate. Scheduling maintenance and attending to the various alarm conditions can prove to be difficult. Individuals have to find time in their schedules to deal with such maintenance and alarm conditions.

Currently, there are no systems which automate the scheduling process. Individuals have to manually enter appointments relating to the alarm conditions or to maintenance issues. Reminders and alarms can be automatically generated but the appointment must still be entered into the individual's calendar. To further complicate matters, if the alarm or maintenance issue requires professional help (e.g. a mechanic), the individual will need to coordinate with the professional's calendar. An opening in both the individual's calendar and the professional's calendar will need to be found and these openings will need to be coordinated to ensure that they match.

There is therefore a need for methods, systems, and devices which mitigate if not overcome the shortcomings of the prior art.

### SUMMARY OF INVENTION

The present invention provides systems, methods, and devices for managing appointments. A sensor module receives sensor data input. The sensor data is then analyzed by an analysis module which determines if actions are required. In the event actions are required, a scheduling module checks a user's calendar to determine if a suitable opening is available. In the event a suitable opening is available, the opening is confirmed with the user. If the user confirms the opening, an appointment is entered in the user's calendar. If the action required needs external assistance, such as a mechanic, the scheduling module also checks the relevant calendar for the external assistance. Suitable openings are then found in both the user's calendar and the relevant external assistance calendar. If these openings match, the user is then contacted to confirm if the opening is acceptable. If the opening is acceptable, the appointment is then entered in both calendars.

In a first aspect, the present invention provides a method for managing appointments, the method comprising:
a) determining a need for an appointment based on an analysis of sensor data;
b) checking a user's calendar for an opening suitable for said appointment;
c) entering said appointment in said user's calendar after said opening is confirmed by said user.

In a second aspect, the present invention provides a system for managing appointments, the system comprising:
a sensor data analyzer for analyzing sensor data; and
a scheduler for entering appointments in a user's calendar;
   wherein
said scheduler enters appointments in said calendar based on an analysis of said sensor data.

Based on analysis of sensor data and determination that they user needs to take some action, the invention sets up one or more appointment for the user to take action. By automating the scheduling of appointments, it is easier for the user and also increases the likelihood that the user will act on the recommended action.

In one embodiment, useful for users seeking to lose or maintain their weight, the system schedules an exercise session for the user by checking their calendar to find empty slot or opening and booking an appointment. The user is allowed to confirm or reject the appointment. If confirmed, the appointment is entered. If rejected, the system will select another appointment or the user can propose an alternative appointment. The system can also track rejected appointment slots and successful appointments slots and use that knowledge to select future exercise appointments. For example, the system can learn that the user prefers to exercise early mornings on weekdays, and in the afternoon on the weekends.

In another embodiment, the system can automatically schedule a car maintenance or appointment based on the car owner's availability, the availability of the maintenance or repair facility, and the severity of the problem.

### BRIEF DESCRIPTION OF THE DRAWINGS

The embodiments of the present invention will now be described by reference to the following figures, in which identical reference numerals in different figures indicate identical elements and in which:

FIG. 1 is a generalized block diagram of a system according to one aspect of the invention;

FIG. 2 is a block diagram of a system according to one implementation of the invention;

FIG. 3 is a flow diagram of one example of how the invention may be used;

FIG. 4 is a flowchart detailing the steps in a method according to one aspect of the invention; and

FIG. 5 is a flowchart detailing the steps in a method according to another aspect of the invention.

### DETAILED DESCRIPTION OF THE INVENTION

For clarity, the term “cloud” or “cloud computing” throughout this document will mean the use of computing resources (hardware and software) that are delivered as a remote service over a network (typically the Internet). As one example, a user's calendar may be referred to as being “stored in the cloud”. This is to mean that the user's calendar is stored and accessible through a server physically remote from the user and accessible to the user by way of the Internet.

Various sensors which generate data may be used to determine if a user has to act given differing circumstances. The data from these sensors is collected and analyzed and the results may be reported to the user. Depending on the report, the user may be required to take some action. As an example, if the smoke detector reports an alarm the user takes immediate action. In the case of health sensors such as a weighing scale, the scale reports to the user that his or her weight is increasing or is not going down as required. It is then up to the user to decide what action to take to address the problem. In this case, the user should exercise more and perhaps make better eating choices. In some solutions the program makes the appropriate recommendations but it still becomes the user responsibility to decide when to take action. Often the user does not act.

Sensors may also be used to determine if a user has to perform some action relating to the repair or maintenance of his or her belongings. As an example, a user may own or operate a car equipped with sensors that report problems with the car. This problems are diagnosed by the car's internal diagnostic systems based on sensor data generated by sensors in the car. Based on the sensor data, the diagnostic systems can recommend that the owner take the car to the shop for repair. It is up to the user to call up the shop and make an appointment for the car to be taken in for repairs or maintenance.

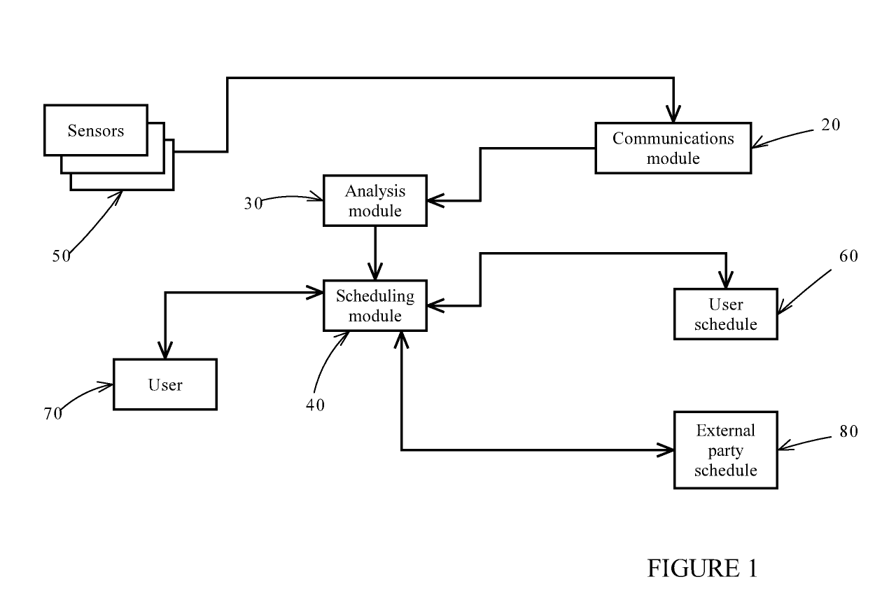

Referring to FIG. 1, a block diagram of a system according to one aspect of the present invention is presented. The system 10 has a communications module 20, an analysis module 30, and a scheduling module 40. The communications module 20 receives sensor data from sensors 50. The received sensor data is then passed to the analysis module 30 that analyzes not just the sensor data but the implications of the sensor data readings (e.g. the severity or urgency of a required action). The results of the analysis, such as the action required and the urgency of that action, is passed to the scheduling module 40. The scheduling module 40 then communicates with the user's electronic schedule to determine if a suitable opening or slot in the schedule is available. If a suitable opening is found, the date, time, and circumstances surrounding the opening is communicated to the user for confirmation. If the user confirms the available opening, the scheduling module 40 then adds the appointment to the user's schedule 60.

It should be noted that if the action required involves or requires a third party or an external party, the schedule for that external party will need to be checked and coordinated with the user's schedule. The scheduling module 40 will thus have to communicate with the external party's schedule 80 to determine if a suitable opening or slot is available. If a suitable opening is found, this is then coordinated with the user's calendar to determine if the same opening is available for the user's calendar. If the same opening is not available, the scheduling module 40 then repeats the process of finding suitable matching openings in both the user schedule and the external party schedule.

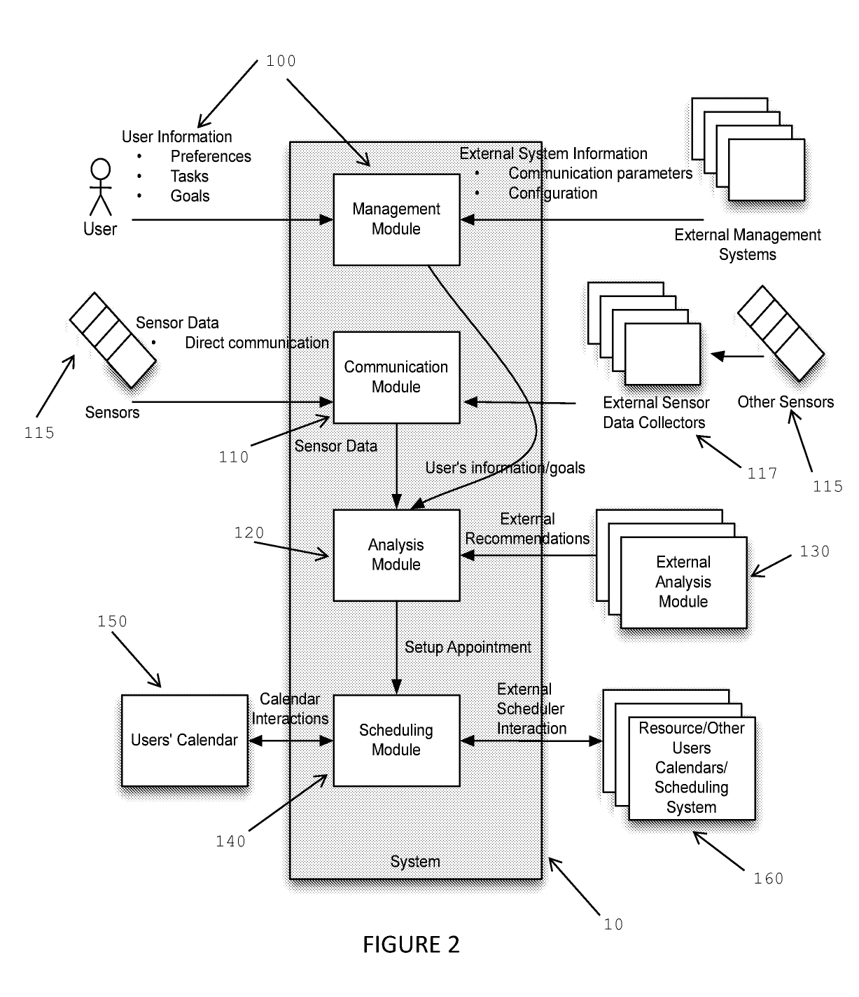

Referring to FIG. 2, the various components of one implementation of the invention is illustrated. The system has an input module 100 that provides the user with the ability to enter information about the user and the task(s) that pertain to the user. The configuration of the system can be done through the input module 100. As an example, the location of the user's calendar, whether it is cloud-based or whether it needs to be accessed through the user's computer, can be entered through this module. The input module 100 includes a management module through which the user enters and stores user preferences. As an example, the user may enter and store preferred garages for automobile repair and maintenance, the user's doctor and his or her contact information, or a desired weight or goal weight that the user is working towards. Similarly, the management module also stores communication and/or configuration parameters which the system may require. The configuration parameters may include the network address of the user's calendar, the passwords and user names required to access that calendar, the network address of the preferred garage's schedule, the relevant parameters and authentication data which may be required for external schedules, configuration data for the various sensors from which the system receives sensor data, and other configuration data which may be required by the system. It should be noted that, even though it is not explicitly shown in FIG. 2, the management module may communicate with the other modules in the system to pass configuration and/or communication data as necessary.

The system further consists of a communication component 110 that can receive sensor data streams directly from various sensors 115 such as weight scales, automotive sensors, and other types of sensors. The communication component can also receive data from other systems or components 117 that collect sensor data information. Such other systems can include applications in the cloud that connect to the various sensors (e.g. a weight scale) or applications which collect data from other means such as manual user entry.

The system also includes an analysis module 120. The analysis module can perform real-time analysis of the sensor data as it is received and it can also analyze historical data. For the historical data analysis, the historical sensor data can be analyzed for patterns or trends that may be useful or of interest to the user. As an example, the analysis module can analyze historical sensor data to detect a weight loss trend, or weight gain trend. Similarly, the analysis module can detect if there is an increase or a decrease in the frequency of repairs for specific components or subsystems of the car. The analysis module may provide determinations and conclusions based on the sensor data and previously entered limits and acceptable ranges on the sensor data. In one implementation, the analysis module can determine the severity of the condition indicated by the values in the sensor data. As an example, if the sensor data is received from a blood pressure monitor, a higher blood pressure indicated by the sensor data can be concluded as indicating a higher severity. For some cases, the analysis module would expect a specific range of values for the sensor data. Severity, in one configuration, may be determined by the difference between the expected range of values and the actual sensor data readings. The larger the difference between the two may indicate a higher severity.

As an alternative embodiment, the analysis module may also receive analysis data from other external analysis modules 130. As an example of this alternative, the external analysis modules 130 may perform the intensive analysis which might be required by the sensor data. For the weight loss example given above, an external analysis module may report that the user needs to exercise. For the car maintenance example above, the external analysis module may receive sensor data or a maintenance notification from an external automotive diagnostic function.

The system 10 also has a scheduling module 140 that facilitates the scheduling of an appointment for the user that may involve other users/resources. To find suitable openings or open slots in a user's electronic calendar, the scheduling module 140 is able to interrogate or query the user's calendar 150 to locate a slot. The user's calendar 150 can run as an application on the user's machine or be in the cloud. The interrogation can be performed by several means known to those skilled in the art. As examples, the user calendar can be queried using an API provided by the calendar service. The interrogation can also be performed by allowing the scheduling module to log into the calendar (using information provided by the user via the management module) and then using techniques such as screen scraping to determine if there are any openings or free slots in the calendar.

In order to coordinate the user's availability with the availability of other resources or people, the scheduling module 140 can connect to other shared calendars 160, or to other external systems 160 to extract availability. Preferably, the scheduling module has the ability to learn the user's preferences by recording and analyzing the user's previous scheduling activities. Using the user's schedule, the availability of other resources or people, the user's preferences, the importance of the event, the severity of the condition indicated, the scheduling system 10 proposes an appointment/meeting. The proposed appointment can be directly recorded into the user's calendar and/or it can be sent as an invite for confirmation by the user. If other resources are involved, the system can send an invite or a confirmation to those resources via mail or an available API.

Upon receiving the appointment notification or confirmation, the user can accept it, reject it or propose an alternative. The appointment may receive input from other resources/people required for the meeting. They scheduling system can also propose alternative appointment slots based on the received responses.

In the weight management example given above, the weight sensors would generate sensor data relating to the user's weight. This sensor data would then be passed to the analysis module. The analysis module would analyze the data to monitor the user's weight over time. In the event the sensor data over time indicates that the user is either not losing weight or is, in fact, gaining weight, the analysis module would indicate than an action is required. The analysis module may, in one example, use an averaged value as the criteria for determining weight loss, maintenance, or gain. A 7 days' worth of sensor data can be averaged by the analysis module to determine the user's weight maintenance. If the immediately preceding 7 day average weight is within a predetermined range of the current 7 day average weight, then the analysis module can conclude that the user is maintaining his or her weight. If the immediately preceding 7 day average is lower than the current 7 day average weight, then it can be concluded that the user is gaining weight.

Once it has been determined that the user is gaining weight or is only maintaining his or her weight, the required action can be implemented. This action may be that of setting aside time (i.e. set an appointment) in the user's schedule to exercise. Once this has been determined, the scheduling module can query the user's calendar and any predefined user preferences for time slots for exercise to find a suitable time slot or opening for exercise. Once the scheduling module finds the suitable time slot in the user schedule, the user is notified about the proposed appointment. The user may be notified by email, text messaging, a pre-recorded voice mail message, or any other suitable means. The user can then accept, reject, or propose a different time slot. If the user proposes a different time slot, the scheduling module then checks if the proposed time slot is available in the user's calendar. If the proposed time slot is available, then an appointment is made for that time slot. If the user rejects the time slot proposed by the scheduling module, the scheduling module then restarts the process and looks for a different time slot. If the user accepts that time slot proposed by the scheduling module, an appointment is entered in the user's calendar for that time slot.

It should be noted that the user's preferences regarding appointments, types of appointments, open time slots, and other scheduling preferences can be entered by the user using the input component 100. This can be entered manually using a graphical user interface and the input component 100 may be accessible to the user using any suitable type of computing device. The computing device may be a computer, a tablet computer, a smartphone, a desktop computer, gaming console, and the like.

It should also be noted that the scheduling module is preferably capable of complex logic and actions based on that logic. As an example, if the user prefers personal time appointments (e.g. appointments for exercise or for relaxing) in 2 hour increments and should not be within 30 minutes or a half hour of work type appointments, the scheduling module should seek time slot openings that meet these criteria. The scheduling module can first seek openings in the user's calendar which meet the first criterion, that of being a 2 hour time window. Once all of these openings have been found, these are then evaluated based on the second criterion, that of not being within 30 minutes of a work appointment. Those time slots which do not meet the second criterion are then discarded. The time slots which meet both first and second criterion can then be further evaluated using other criteria which may apply.

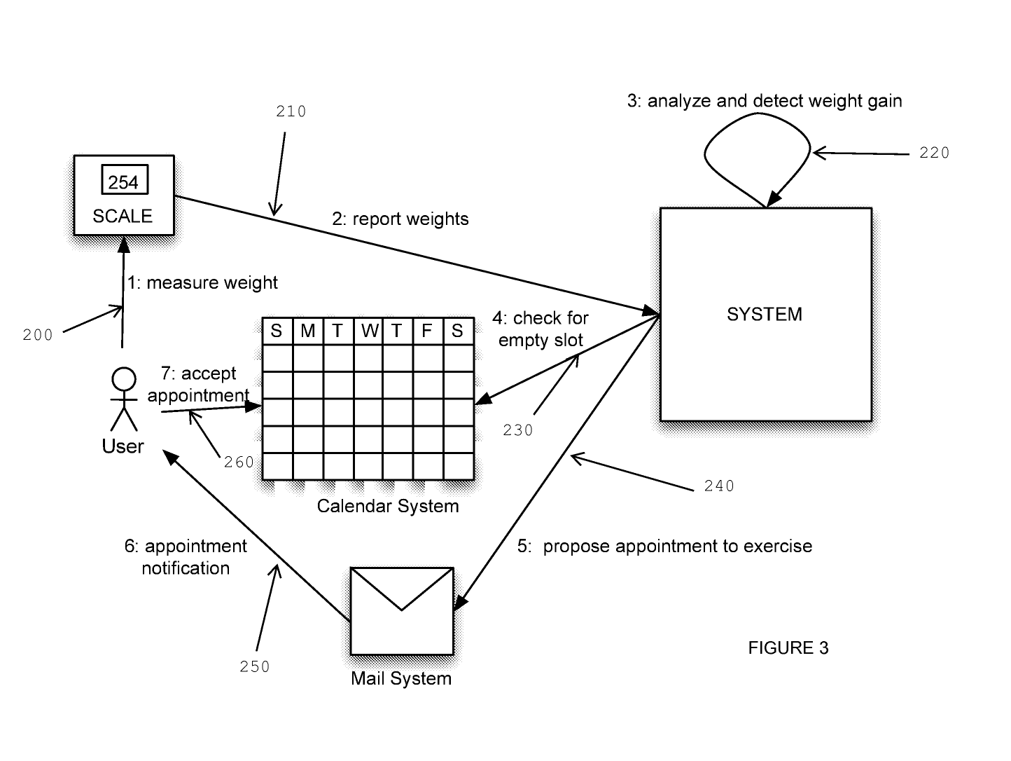

To further clarify the above example regarding weight monitoring, FIG. 3 illustrates a flow diagram for the above example. In FIG. 3, the process begins with the measuring of the user's weight (flow 200). The scale (being used as a sensor) that measures the weight then reports the sensor data (the user's weight) to the system (flow 210). The sensor data is then analyzed by the system and, based on the current and past sensor data, a determination is made that the user has gained weight (flow 220). A further determination is made that the user needs exercise and that an appointment will need to be made for this exercise.

After the determination is made that exercise is needed, the system than checks the user's calendar for an opening suitable for the exercise appointment (flow 230). As noted above, the search for the opening in the calendar can be based on predefined criteria that the opening has to meet. Once the suitable opening has been found in the user's calendar, that opening is proposed to the user by way of a communication (flow 240). The proposed appointment is then delivered to the user (flow 250). The user then confirms the appointment (flow 260).

As noted above, the user enters his or her preferences into the system 10 by way of the input module 100 (which includes the management module). At the same time, the user can enter the necessary authentication data (e.g. passwords, email addresses, website address for calendar and/or email, cell number for text messages, etc.) into the system to allow the system access to the user's calendar and to allow the system to communicate with the user. The user can also configure the scheduling system 10 by way of this input module 100. As examples, the user can enter the preferred garage for servicing his automobile, his preferred methods of exercise (ranked by preference), and his doctor's office contact information (for required medical actions or appointments).

The user can configure the scheduling system using the input module 100 via a graphical user interface through the user's web browser or an application running on the user's tablet. The configuration includes specifying the weight goals, and registering the weight scale as a sensor providing sensor data to the scheduling system. As well, the user specifies their email address and provides information about their calendaring software, including providing credential to allow the system to access their calendar.

The user begins to use the scale every day. The scale data, as sensor data, is sent to the scheduling system where the sensor data is received by the communication module 110, which passes the data to the analysis module 120.

The analysis module 120 analyzes the data using a predefined algorithm on the received sensor data and the user's goals. The analysis module then determines, in one example, that the user's weight is not meeting the user's goal—the user's weight is either increasing or not decreasing.

The analysis module 120 then sends an event to the scheduling module 140 indicating that an appointment is needed for the user to exercise or for the user to increase his or her exercise in the next coming day or in the next few days. It should be noted that the timing of the exercise can be configured by the user. As an example, if there is weight gain, the user could configure the scheduling system to look for an appointment slot in the next two days. If there is no weight gain but merely a lack of weight loss, the user could configure the scheduling system to look for an appointment slot in the next week.

Once the scheduling module 140 has received the action required from the analysis module 120, the scheduling module 140 uses the credentials and authentication data provided by the user to access the user's calendar to locate an appropriate free slot for the user to exercise. The user's preference for exercise—for example, one hour of walking—is entered into the scheduling system during user setup procedure using the input module 100. When searching for a suitable opening in the user's calendar, the scheduling module can take into account factors other than what has been entered by the user. As an example, if the user prefers to exercise outside, then weather information provided by a third party weather service can be taken into account. If the weather forecast for the proposed appointment time indicates inclement weather, a different time can be organized or an indoor activity can be organized and suggested to the user. The scheduling module 140 then sends the proposed appointment slot (perhaps as a meeting invitation) for exercising to the user via the user's preferred method of contact. This preferred method of contact can be via email, text, or any other suitable communication method.

The user receives the meeting invitation and accepts it. The scheduling module, upon receipt of the acceptance, then enters the appointment in the user's calendar. The user could also have responded to the invitation by proposing a new time and/or activity. Similarly, the user could have decided to reject the invitation. The scheduling module will receive either of the responses and will process the proposed new time or the rejection. The scheduling module will keep track of all of the user's responses in a database so that, for future exercise related appointments, the scheduling module can learn when the user prefers to exercise.

In one variant, the system can assist in determining whether the user is progressing towards his or her goals. For this variant, sensors can detect the user's performance during the appointment—sensors on an exercise bicycle or sensors worn by the user can detect how long the user has exercised, the distance the user has traveled (if jogging or bicycling), or other exercise related data that can be used to assess the user's exertion. This data can then be used to assess how many calories the user has burned or whether the exercise is sufficient to meet or progress towards the user's predetermined weight goals. The sensor data can be stored in the system and can be used by the analysis module to determine whether more appointments are required, the duration of those appointments, and perhaps even the type of exercise that the user should be engaging in.

As another example of an implementation of the above invention, described below are details concerning car repair and/or maintenance and how the scheduling system can be used to simplify the scheduling of appointments for car repairs.

In this example, the user owns an automobile or any other type of equipment that requires periodic maintenance and repair at a repair depot such as a garage. The automobile is equipped with sensors that sense conditions relating to the health or maintenance status of at least one of the automobile's subsystems. As an example, the automobile can be equipped with sensors that detect the tire pressure on the automobile's tires. As another example, the automobile can be equipped with sensors that detect and measure the oil pressure in the engine, the timing of the cylinders in the engine, and the age of the oil in the engine. It should be noted that the age of the oil in the engine may be relevant in determining when a regular oil change may be needed for the automobile.

For this example, the automobile has a sensor package that monitors the systems of the automobile and which reports information regarding the status of the automobile to a cloud-based web portal owned by the car company. The portal is where the automobile's information is diagnosed. Depending on the information from the sensors, the diagnosis may determine that the car should be brought in for service. In some cases, service will be required immediately and in other cases the need for the service will not be as immediate.

The diagnosis regarding the automobile's service requirements is then sent to the communications module 110 by way of a preconfigured communications channel. From the communications module, the diagnosis is passed to the analysis module 120. The analysis module 120 then further analyzes the data to determine when and who should be involved in the matter. The timing of the service appointment can be based on the severity of the diagnosis. Of course, a higher severity indicated can be taken as an indication that an earlier or sooner appointment may need to be sought.

The request to setup an appointment is then sent from the analysis module 120 to the scheduling module 140. The scheduling module 140 will interface and query the external calendars for available slots. In this case, the external calendar would be that for the garage or car shop. Similarly, the scheduling module 140 will interrogate the user's calendar to find available spots.

The available spots will be assessed against the user's entered preferences as well as against the user's other preferences which have been gathered based on previous interactions and previous appointments. As an example, if the user has stated a preference for Tuesday car appointments, then the scheduling system will search for Tuesday openings first. As another example, if the user has switched or rejected all car appointments which were scheduled on a Wednesday, then this would indicate the user's preference to not schedule car appointments on Wednesdays. This means that Wednesday open slots can be discounted.

Once a suitable opening has been found in both the user's calendar and external calendar, suitable opening found on the external calendar is entered for that calendar as an unconfirmed appointment. The date and time for the suitable opening is then sent to the user for confirmation. This is done by way of email, text message, instant message, or any other suitable communication channel for the user. Upon receiving the notification, the user may accept it, reject it, or propose another time. If the user does not respond to the confirmation notification within a given time period, then the scheduling system will cancel the reservation/appointment entered as an unconfirmed appointment on the garage's calendar.

Alternatively, if the user accepts the confirmation notification and the time period for responding has not expired, the scheduling module 140 confirms the appointment with the garage and the external calendar entry is entered as a confirmed appointment. If time period has expired and the user attempts to confirm the proposed appointment, then a new appointment needs to be setup. The scheduling module 140 then repeats the steps given above to search, schedule, and confirm a new appointment.

In the event the user proposes a new time slot over the available opening found by the scheduling module 140, the scheduling module 140 checks with both the external calendar (in this case the garage's calendar) and the user's calendar to determine whether the proposed new time slot is available on both calendars. If the proposed new time slot is still available, the scheduling module 140 enters the appointment in both the user's calendar and the external calendar as a confirmed appointment. If the proposed new time slot is not available on either calendar, the scheduling module can look for another time slot that is available for both calendars and which conforms to the user's preferences. Alternatively, the external calendar can actively propose a time slot to the scheduling module.

Once another time slot has been found, the scheduling module again marks the time slot on both calendars as being an unconfirmed appointment. The user is then sent a counter-proposal appointment which the user can accept or reject. If the user sends a rejection, then the scheduling module removes the unconfirmed appointment in the external calendar as well as the unconfirmed appointment in the user's calendar. It should be noted that the system can be configured to only search for a suitable opening for a specific number of times. Thus, if, after 3 potential openings have been found and rejected by the user, the system can be configured to stop searching for a suitable opening. The system can send a communication to the user informing the user that a suitable opening could not be found. Alternatively, the system can keep searching for an opening and can continuously keep suggesting openings to the user. Of course, for this configuration, the user can tell the system to stop searching at any time. This may be done by the user interacting with the input module.

As an alternative configuration, the scheduling module 140 may also query external parties for confirmation regarding unconfirmed appointments entered in their calendar. In one example, a user may need a doctor's appointment because sensor data indicates the user's blood sugar levels are very elevated (e.g. in double digits when the user's blood sugar level is usually in single digits). Such an indication of an alarm condition, determined from sensor data gathered from the user's glucometer, may be placed in a higher level of severity than other conditions such as a slight elevation of the user's blood sugar. For this example, the scheduling module 140 queries a doctor's office calendar to determine a suitable opening. Once a suitable opening has been found that is available in both the user's calendar and the doctor's calendar, both the doctor's office and the user are queried for confirmation. Only when both parties have communicated their approval of the proposed appointment is the appointment entered in the two calendars as a confirmed appointment.

In one variant of the invention, the scheduling module 140 can search and determine multiple openings in the user's calendar suitable for a specific appointment. Instead of proposing only one opening for that appointment to the user, the scheduling module can communicate all suitable openings to the user. The user can then select which opening is acceptable. This concept can be extended to situations requiring multiple external parties. The scheduling module 140 can extract multiple openings in the various calendars involved and communicate all the openings common to all calendars to the various parties. The various parties (e.g. the user, his mechanic, and the garage/car service facility) can then indicate which of the openings are acceptable. The scheduling module 140 can then coordinate and find the openings that are available to all the parties involved. These openings can then be presented again to the parties until a single opening is determined. At this point, the scheduling module 140 can then enter the appointment in the single opening in all the calendars.

In another variant, an appointment can be scheduled for the user even when the user's calendar does not have a suitable opening. Depending on the severity of the issue, the system can schedule an appointment for the user even if the user does not have an opening in his schedule. The appointment can be based on an opening or openings in an external calendar. As an example, if sensors in the user's automobile indicate a potentially dire issue (e.g. very low tire pressure, 5% oil life left, or some other potentially debilitating condition for the automobile), the system can search for an opening on the garage's schedule and schedule an appointment for the user in that opening. As noted above, this can be done even if the user's schedule does not indicate a similar opening. The direness or severity of the issue can be used as the grounds for scheduling an appointment even if the user is determined to not be available for the opening.

It should be noted that the principal concepts explained in relation to the two main examples given above can be applied to a myriad of situations and circumstances. The invention can be used to receive sensor data or results of analyses of sensor data. The sensor data can be used to determine if an action or an appointment is required, if a condition exists that requires an action or appointment, the severity of that condition, and the desired timing of the action or appointment required.

The invention can be used to set up appointments in the user's calendar based on the results of the analysis of the sensor data. The appointments can be scheduled based on the user's preferences as entered by the user. The appointments can also be scheduled based on the user's preferences as determined by the user's previous interactions. The scheduling module can be used to coordinate an appointment between the user's calendar and multiple external calendars if necessary. In the above example, a single external calendar was used in the coordination. However, multiple external calendars may be coordinated along with the user's own calendar.

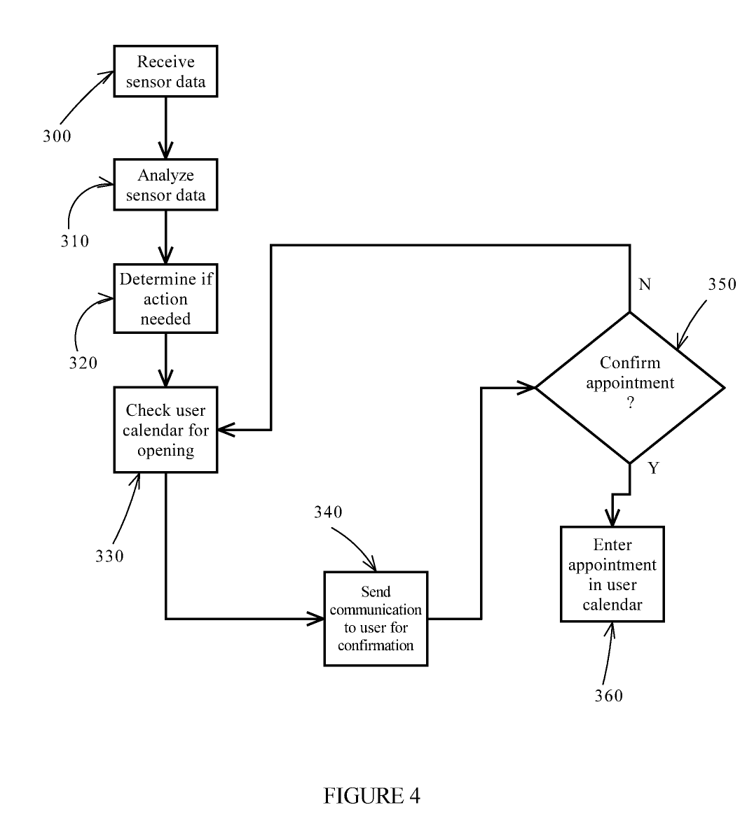

Referring to FIG. 4, a flowchart detailing the steps in a generalized method according to one aspect of the invention is illustrated. The method begins at step 300, that of the scheduling system receiving sensor data. This step may include receiving the results of sensor data analysis performed by an external analysis module. Step 310 is then that of analyzing the sensor data received. As noted above, the sensor data analysis may include one or more of the following: determining if the values for the sensor data is outside of a predetermined range, determining if values for the sensor data is higher than a predetermined trigger value, determining if values for the sensor data is lower than a predetermined trigger value, determining if values for the sensor data indicates an alarm condition, and determining a severity of an alarm condition based on said sensor data.

Once the sensor data has been analyzed, step 320 then determines if the values in the sensor data indicates a need for an action and/or an appointment. Depending on the configuration of the scheduling system and the situation, a threshold or trigger value may be used to determine if a condition is severe enough to warrant an action or an appointment. As an example, a user's blood pressure may be slightly elevated but the increase in blood pressure may not be high enough to warrant a visit to the user's doctor. Similarly, the condition indicated by the sensor data may be a temporary increase and historical sensor data may not indicate a need for action. As one example, a user's weight may have increased by a few pounds for a few days but, taken in a longer term view, this may not indicate a permanent condition. As such, the need for exercise may not be warranted. It should be noted that the trigger value may be used as an upper limit or a lower limit when determining a need for action. Thus, depending on the configuration of the system, sensor data which indicates values higher than the trigger value or which indicates values lower than the trigger value maybe determinative of whether an action or appointment may be required.

After it has been found that a need for action and an appointment is required, the scheduling system queries the user's calendar for an opening suitable for the appointment (step 330). This step may involve assessing any openings found against the user's stated preferences as well as against the user's determined preferences. As noted above, the user's stated preferences are entered by the user by way of the input module 100 and may be done when the user is configuring the scheduling system. The user's determined preferences are the user's preferences which have been derived by analyzing the user's previous choices.

Step 340 is that of sending a communication to the user to confirm the selected opening or openings found for the appointment. Step 350 determines if the opening has been confirmed or not by the user. If the user has rejected the opening, then the logic flow continues to step 330 and the loop continues. If, on the other hand, the appointment has been confirmed by the user, the step 360 is that of entering the appointment in the user's calendar as a confirmed appointment.

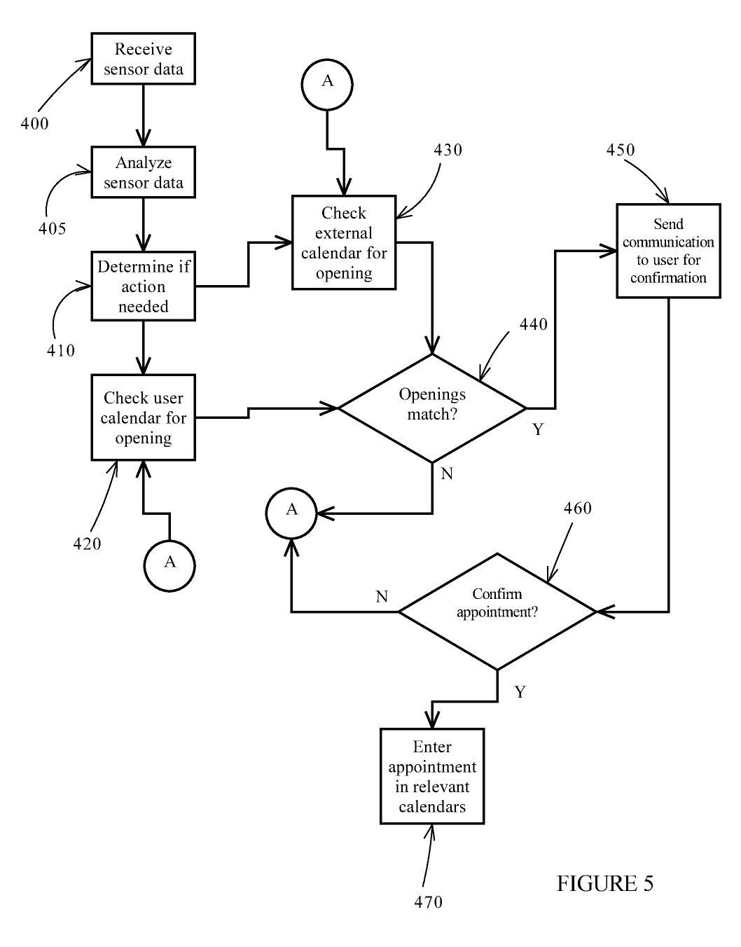

Referring to FIG. 5, a flowchart of a method according to another aspect of the invention is illustrated. For this method, at least one party other than the user is involved in the scheduling process.

In FIG. 5, the method begins at step 400, that of receiving sensor data. Step 410 then determines whether there is a need for an appointment based on an analysis of the sensor data. Once it has been determined that an appointment is necessary, the user's calendar is checked for suitable openings (step 420) and the relevant external calendars are similarly checked for openings (step 430). Of course, the openings to be found would need to conform to the user's preferences, both those preferences explicitly entered by the user and those determined by the system to be the user's implicit preferences. When these openings have been found, step 440 then determines if the openings found on the user's calendar match those found on the external calendar. If there is no match, then the process loops back to steps 420 and 403, that of checking the relevant calendars for suitable openings. It should be noted that the loop between steps 420, 430, and 440 may examine one opening at a time until a suitable matching opening is found.

In the event a suitable opening is found, in step 450 a communication is sent to the user to confirm whether the suitable opening meets with the user's approval. If the user rejects the proposed appointment, then the logic loops back to steps 420 and 430, that of checking the relevant calendars for matching openings.

It should be noted that step 450 may include communicating with the other parties involved to request confirmation of the proposed appointment. In the event one of the parties rejects the proposed appointment, the logic, again, loops to steps 420 and 430.

Once the user has confirmed the proposed appointment, the proposed appointment is entered into the relevant calendars (step 470).

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for managing appointments, the method comprising:
a) determining a need for an appointment based on an analysis of sensor data;
b) checking a user's calendar for an opening suitable for said appointment;
c) entering said appointment in said user's calendar after said opening is confirmed by said user.

2. A method according to claim 1 wherein said method comprises the step of receiving said sensor data prior to step a).

3. A method according to claim 1 wherein step b) comprises logging in to said user's calendar using user-supplied credentials.

4. A method according to claim 1 wherein said analysis in step a) comprises at least one of:
determining if values for said sensor data is outside of a predetermined range;
determining if values for said sensor data is higher than a predetermined trigger value;
determining if values for said sensor data is lower than a predetermining trigger value;
determining if values for said sensor data indicates an alarm condition;
determining a severity of said alarm condition based on said sensor data.

5. A method according to claim 1 wherein step b) comprises determining time slots in said user's calendar which are open.

6. A method according to claim 5 wherein step b) further comprises assessing time slots against user preferences.

7. A method according to claim 6 wherein said user preferences are user-entered user preferences.

8. A method according to claim 6 wherein said user preferences are determined based on previous user choices.

9. A method according to claim 1 wherein step b) further comprises checking an external calendar for openings in the event said appointment also involves at least one party other than said user.

10. A method according to claim 9 wherein step b) comprises determining openings in said user's calendar which match openings in said external calendar.

11. A method according to claim 1 wherein said method further comprises sending a proposed appointment to said user and receiving said user's confirmation for said appointment prior to executing step c).

12. A method according to claim 9 wherein said method further comprises sending a proposed appointment to said user and to said at least one other party and receiving said at least one confirmation for said appointment prior to executing step c).

13. A system for managing appointments, the system comprising:
a sensor data analyzer for analyzing sensor data; and
a scheduler for entering appointments in a user's calendar;
wherein
said scheduler enters appointments in said calendar based on an analysis of said sensor data.

14. A system according to claim 13 further comprising a communications module and wherein said sensor data analyzer receives sensor data from a communications module.

15. A system according to claim 13 wherein said sensor data analyzer receives analysis results from an external module.

16. A system according to claim 13 wherein said scheduler accesses external calendars for entering appointments in the event said appointments involve at least one party other than said user.

17. A system according to claim 13 further comprising an input module for receiving user input.

18. A system according to claim 14 wherein said communication module receives sensor data from at least one sensor.

19. A system according to claim 13 wherein said scheduler accesses said user's calendar by accessing said user's computer.

20. A system according to claim 13 wherein said scheduler accesses said user's calendar by accessing said user's account on a server.
